(19) United States
(12) Patent Application Publication
(10) Pub. No.: US 2015/0381005 A1
(43) Pub. Date: Dec. 31, 2015

(54) Rotary Machine

(71) Applicant: HITACHI, LTD., Chiyoda-ku, Tokyo (JP)

(72) Inventors: Tetsuji KATO, Tokyo (JP); Kohji MAKI, Tokyo (JP); Koji OBATA, Tokyo (JP); Daisuke KORI, Tokyo (JP)

(21) Appl. No.: 14/769,145

(22) PCT Filed: Feb. 25, 2013
(86) PCT No.: PCT/JP2013/054661

§ 371 Date: Aug. 20, 2015

(51) Int. Cl. H02K 3/40

(52) U.S. Cl. CPC H02K 3/40

(57) ABSTRACT

The present invention aims to provide a rotary machine in which deterioration or a burnout of a corona prevention layer in the vicinity of a slot outlet of a stator can be suppressed from occurring. The present invention includes a stator that has a stator core, and a rotor that is arranged so as to face the stator and is rotatably held. In the rotary machine in which a stator coil having a low-resistance corona prevention layer wound around is mounted on the stator core, a conductive member is formed on the stator coil at an end portion of the stator so as to have a structure in which a gap with respect to the stator coil is widened as the conductive member is positioned away from the stator core in a rotary shaft direction of the rotary machine.

### TECHNICAL FIELD

The present invention relates to a rotary machine such as an electric motor and a generator, and particularly relates to a rotary machine which is suitable when being driven by a voltage having a high frequency component.

### BACKGROUND ART

A rotary machine is mainly configured to have a stator and a rotor. The rotor is formed on an inner diameter side or an outer diameter side of the stator, and a stator coil is mounted in a slot of a stator core of the stator. In the stator coil of the rotary machine, in order to suppress a partial discharge in the slot from occurring, there is a case where a low-resistance corona prevention layer is covered with a surface of an insulation layer provided in a stator coil conductor.

Meanwhile, there is a case where the rotary machine is driven by an inverter in order to enhance operating efficiency, and semiconductor materials such as Si, SiC, and GaN are used for the inverter. A voltage applied to the rotary machine by the inverter includes massive high frequency components. NPL 1 discloses that particularly when a voltage including massive high frequency components is applied to the stator coil of the rotary machine, an electric field is concentrated in the vicinity of a slot outlet of the stator, and a large current flows in the low-resistance corona prevention layer, thereby resulting in heat generation of the low-resistance corona prevention layer in the vicinity of the slot outlet of the stator.

As a method of suppressing an electric field from being concentrated in the vicinity of the slot outlet, PTL 1 discloses a method of arranging a member which is made of a resin or metal and of which a cross section has an arc shape or a triangular shape at a distal portion of the stator core, or configuring a configuration in which punched plates or members are stacked in order of decreasing width.

### CITATION LIST

[PTL 1] JP-A-2006-33918

[NP 1] F. P. Espino-Cortes et al., “Impact of Inverter Drives Employing Fast-Switching Devices on Form-Wound AC Machine Stator Coil Stress Grading”, IEEE Electrical Insulation Magazine, Vol. 23, No. 1, pp. 16 to 28, (2007).

### SUMMARY OF INVENTION

### Technical Problem

In the related art, in a rotary machine not driven by an inverter, relatively few high frequency components are included in a drive voltage waveform, and transition times during rising and failing of an input voltage are also relatively moderate. Thus, an electric field in the vicinity of a slot outlet of a stator is small, and a low-resistance corona prevention layer wound around a stator coil of the rotary machine is maintained at substantially the same electrical potential as that of a stator core. Therefore, a current flowing in the low-resistance corona prevention layer in the vicinity of the slot outlet of the stator is small, and heat generation thereof is suppressed to be low. Accordingly, there has been no occurrence of a problem of deterioration or a burnout of the low-resistance corona prevention layer in the vicinity of the slot outlet of the stator.

Incidentally, in the rotary machine driven by the inverter, particularly, a voltage including massive high frequency components is applied to the stator coil of the rotary machine in response to a steep rise of a drive voltage caused by high-speed switching of the inverter, an electric field is concentrated in the vicinity of the slot outlet of the stator, and a large current flows in the low-resistance corona prevention layer, thereby resulting in heat generation of the low-resistance corona prevention layer in the vicinity of the slot outlet of the stator.

Due to high speed switching, when being driven by the inverter using a semiconductor material such as SiC and GaN, there is a case where rising of the drive voltage becomes particularly steep. In such a case, heat generation of the. low-resistance corona prevention layer in the vicinity of the slot outlet of the stator increases.

In addition, there is a case where a voltage having a superimposed surge voltage generated by a difference in characteristic impedance of the inverter, cables, and the rotary machine is input to the drive voltage of the inverter. As a result, an input voltage higher than the drive voltage is applied to the rotary machine. Particularly when a carrier frequency is significant, there is a possibility that a voltage equal to or greater than two times the drive voltage is applied thereto, leading to an increase of heat generation of the low-resistance corona prevention layer in the vicinity of the slot outlet of the stator.

As a method of suppressing an electric field from being concentrated in the vicinity of the slot outlet, PTL 1 discloses that the electric field can be relaxed by arranging a member which is made of a resin or metal and of which a cross section has an arc shape or a triangular shape at a distal portion of the stator core, or configuring a configuration in which punched plates or members are stacked in order of decreasing width.

However, since the rotary machine vibrates when being driven, the stator coil also vibrates. Particularly, in a case of the stator coil of the rotary machine having a significant drive voltage so as to be wound around by the low-resistance corona prevention layer, compared to a low-pressure rotary machine, the stator coil is comparatively long, and thus, vibration of the stator coil increases. Therefore, when nothing is performed but arranging the metal member of which the cross section has the arc shape or the triangular shape at the distal portion of the stator core of the rotary machine having the low-resistance corona prevention layer, or stacking the punched plates or the members in order of decreasing width, a distance between the member and the stator coil varies due to vibration, and thus, it is not possible to stably acquire an effect of electric field relaxation.

Moreover, the distance needs to be widened so as to prevent the stator coil and the member from coming into contact with each other due to vibration, Thus, it is not possible to expect a sufficient effect of suppressing heat generation in the vicinity of the slot outlet of the stator.

Moreover, since the end portion of the stator coil is bent, the end portion of the stator coil and a portion of the member approach each other when vibration is generated. Thus, there is a concern of a rise of an electric field at a position away from the slot outlet, leading to an aerial discharge at the position away from the slot outlet.

From the viewpoint described above, the structure disclosed in PTL 1 is not a sufficient countermeasure from, the viewpoint of suppressing heat generation of the low-resistance corona prevention layer when a voltage including massive high frequency components is applied to the stator coil of the rotary machine.

The present invention has been made in consideration of the above-described, points and aims to provide a rotary machine in which heat generation of the corona prevention layer in the vicinity of the slot outlet of the stator is suppressed, and deterioration or a burnout of the low-resistance corona prevention layer is prevented from occurring even in a case where a particularly high voltage including massive high frequency components is input to the rotary machine.

### Solution to Problem

In order to achieve the aforementioned object, a rotary machine according to the present invention includes a stator that has a stator core, and a rotor that is arranged so as to face the stator and is rotatably held. In the rotary machine in which a stator coil having a low-resistance corona prevention layer wound around itself is mounted on the stator core, a conductive member is formed on the stator coil at an end portion of the stator coil so as to have a structure in which a gap with respect to the stator coil is widened as the conductive member is positioned away from the stator core in a rotary shaft direction of the rotary machine.

In accordance with a configuration described above, even in a case where a voltage including a high frequency component is applied, an electric field can be prevented from being concentrated in a slot outlet of the stator. Moreover, an influence of vibration can be suppressed by forming the conductive member at the end portion of the stator coil.

### Advantageous Effects of Invention

According to the present invention, even in a case where a voltage including massive high frequency components is applied to a rotary machine, it is possible to obtain the rotary machine in which deterioration or a burnout of a corona prevention layer in the vicinity of a slot outlet of a stator can be prevented from occurring.

### BRIEF DESCRIPTION OF DRAWINGS

FIG. 1 is a perspective view of an enlarged portion illustrating a slot outlet portion of a stator, illustrating a first embodiment of a rotary machine in the present invention.

FIG. 2 is a schematic longitudinal sectional view in the vicinity of a slot outlet, of a stator coil, illustrating the first embodiment of the rotary machine in the present invention.

FIG. 3 is a schematic view of an electric motor in the related art.

FIG. 4 is a schematic cross-sectional view in the vicinity of the slot outlet of the stator coil of the electric motor in the related art.

FIG. 5 is a characteristic diagram illustrating an example of a relative comparison of a calorific value in the vicinity of the slot outlet portion of the stator between the electric motor in the related art and the first embodiment of the rotary machine in the present invention.

FIG. 6 is a schematic longitudinal sectional view in the vicinity of the slot outlet of the stator coil, illustrating a second embodiment of the rotary machine in the present invention.

FIG. 7 is a schematic diagram of a conductive member illustrating a third embodiment of the rotary machine in the present invention.

FIG. 8 is a schematic diagram of the conductive member illustrating a fourth embodiment of the rotary machine in the present invention.

FIG. 9 is a schematic diagram of the conductive member illustrating a fifth embodiment of the rotary machine in the present invention.

FIG. 10 is a schematic diagram of the conductive member illustrating a sixth embodiment of the rotary machine in the present invention.

FIG. 11 is another schematic diagram of the conductive member illustrating the sixth embodiment of the rotary machine in the present invention.

### DESCRIPTION OF EMBODIMENTS

### Example 1

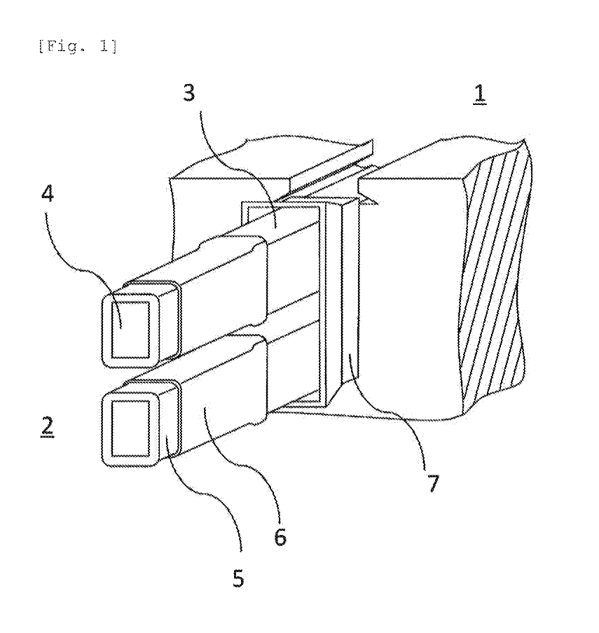

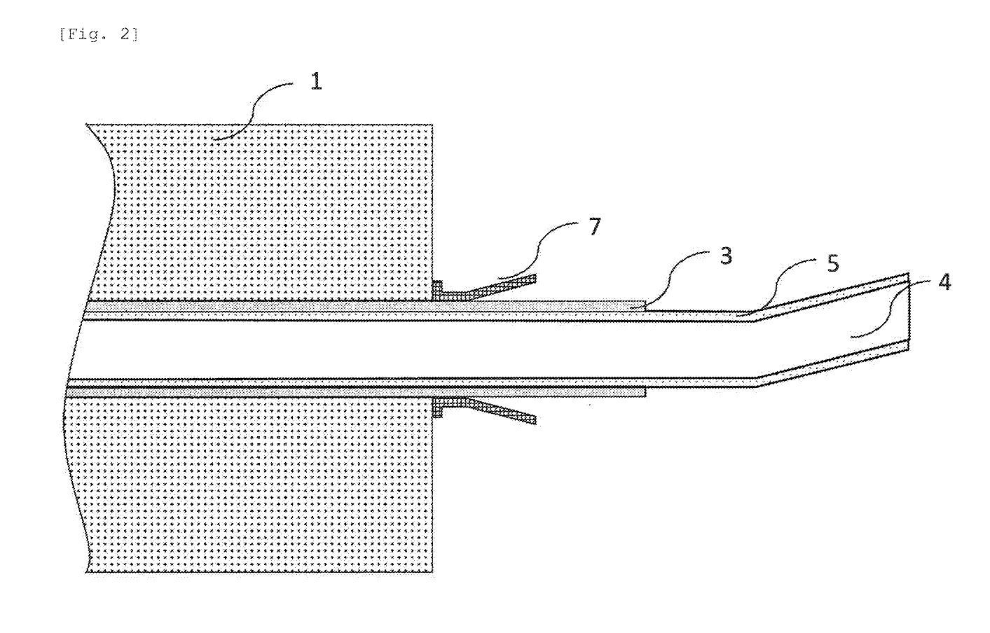

A rotary machine according to the present invention will be described with reference to the drawings. FIGS. 1 and 2 are a perspective view of an enlarged portion illustrating a slot outlet portion of a stator, and a schematic longitudinal sectional view in the vicinity of a slot outlet of a stator coil, illustrating a first embodiment of the rotary machine in the present invention.

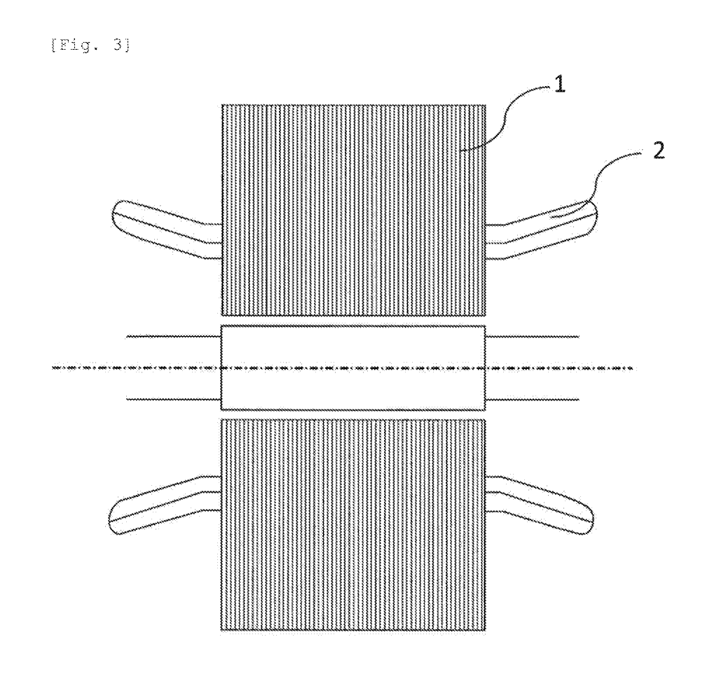

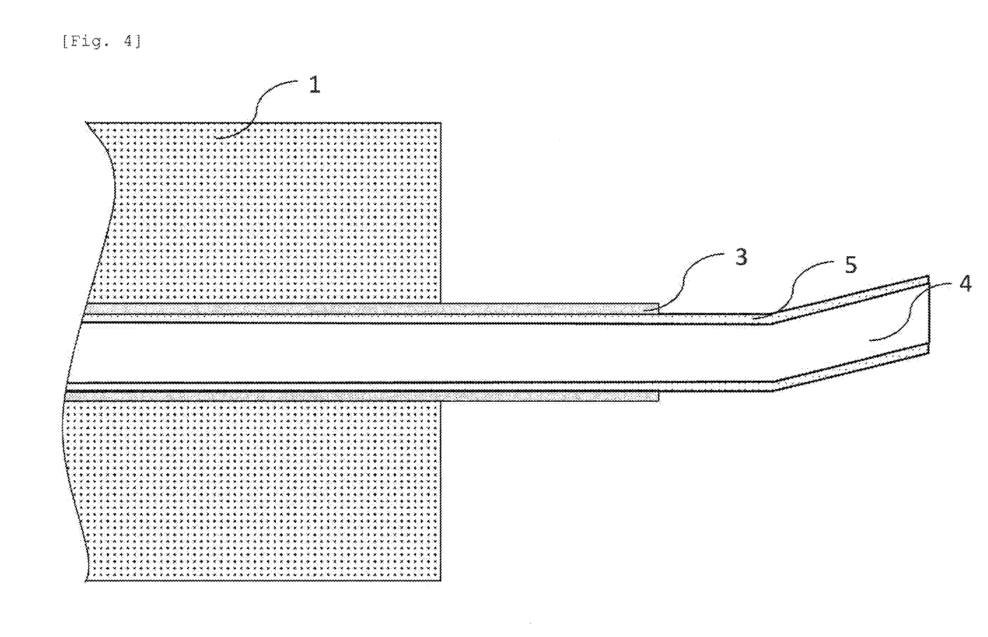

A form of the present invention will be described based on a difference of which a general idea is illustrated in FIGS. 3 and 4 with respect to an electric motor in the related art.

As illustrated in FIG. 3, the stator is schematically configured to have a stator core which is configured by stacking a plurality of magnetic steel sheets in a shaft direction, a plurality of slots which extend in the shaft direction on an inner diameter side or an outer diameter side of the stator core and which are formed at predetermined intervals in a circumferential direction, and the stator coils which are mounted in the plurality of slots.

As illustrated in FIG. 4, the stator coil is formed with a coil conductor and an insulation layer which is formed on a surface of the coil conductor. Moreover, the stator coil is configured to have a linear portion which is mounted in the slot of the stator, and an end portion outside the slot.

On an outer circumference of the insulation layer of the linear portion mounted in the slot of the stator coil, a low-resistance corona prevention layer is covered in order to prevent a corona discharge between the stator core and the stator coil. In addition, at the end portion of the stator coil, an electric field is concentrated in a distal portion of the low-resistance corona prevention layer, thereby leading to a concern that a creeping discharge is generated and deterioration of the low-resistance corona prevention layer or the insulation layer is caused. Thus, there is a case where the distal portion of the low-resistance corona prevention layer is partially covered and an electric field relaxation layer is covered in a direction away from the stator core in a rotary shaft direction of the rotary machine.

The stator coil having such a configuration is connected to a power source such as an inverter having a high frequency component, thereby driving the electric motor.

In the rotary machine driven by the inverter, when a voltage particularly including massive high frequency components is applied to a coil of the rotary machine in response to a steep rise of a drive voltage, an electric field is concentrated in the vicinity of the slot outlet of the stator, and a large current flows in the low-resistance corona prevention layer, thereby resulting in Heat generation of the low-resistance corona prevention layer in the vicinity of the slot outlet of the stator.

Particularly, due to high speed switching, when being driven by the inverter using a semiconductor material such as SiC and GaN, heat generation of the low-resistance corona prevention layer in the vicinity of the slot outlet of the stator increases.

In addition, there is a case where a voltage having a superimposed surge voltage generated by a difference in characteristic impedance of the inverter, cables, and the rotary machine is input to the drive voltage of the inverter. As a result, an input voltage higher than the drive voltage is applied to the rotary machine. Particularly when a carrier frequency is significant, there is a possibility that a voltage equal to or greater than two times the drive voltage is applied thereto. In such a case, heat generation of the low-resistance corona prevention layer in the vicinity of the slot outlet of the stator increases.

In the configuration in the related art, an electric field is concentrated in the vicinity of the stator core when applying a surge voltage, and a large current flows in the low-resistance corona prevention layer. Thus, there is a concern of deterioration or a burnout of the low-resistance corona prevention layer.

Therefore, in the present embodiment, as illustrated in FIGS. 1 and 2, a conductive member is formed on the stator coil at the end portion of the stator so as to have a structure in which a gap with respect to the. stator coil is widened as the conductive member is positioned away from the stator core in the rotary shaft direction of the rotary machine.

In order to acquire the effect of the present invention, it is desirable that electrical contact is achieved between the conductive member and the stator core . As a method thereof, for example, there is a method of arranging the conductive member and the stator core so as to be in contact with each other. However, the method is not particularly limited thereto, and connection may be performed by using a cable and the like.

In addition, even though the conductive member and the stator core are not in direct contact with each other or in connection through a cable or the like, connection may be performed via metal such as a presser plate of the stator core.

By arranging the conductive member on the stator coil, an electric field is suppressed from being concentrated in the vicinity of the slot outlet, and a potential gradient in the rotary shaft direction of the rotary machine of the low-resistance coronet prevention layer becomes gentle. Thus, it is possible to decrease a current flowing in the low-resistance corona prevention layer and to suppress heat generation of the low-resistance corona prevention layer.

As a material which can configure the conductive member, it is possible to apply a material such as metal and conductive plastic having conductivity equal to or greater than 10⁻² [1/Ωcm].

In addition, it is not necessary to form the conductive member by using only metal and conductive plastic. For example, the conductive member may be formed by granting conductivity through a conductive paint or deposition of metal applied on a surface of the member formed of an insulation resin and the like.

Processing of the conductive member may be performed by bending four sheets of metal plates so as to have a widening gap with respect to the stator coil as the conductive member is positioned away from the stator core in the rotary shaft direction of the rotary machine when being attached to the stator coil, and fixing the metal plates onto the periphery of the stator coil. However, the processing method is not particularly limited thereto. For example, the conductive member may be formed in the periphery of the coil by bending one sheet of the metal plate so as to have a widening gap with respect to the stator coil as the conductive member is positioned away from the stator core in the rotary shaft direction of the rotary machine.

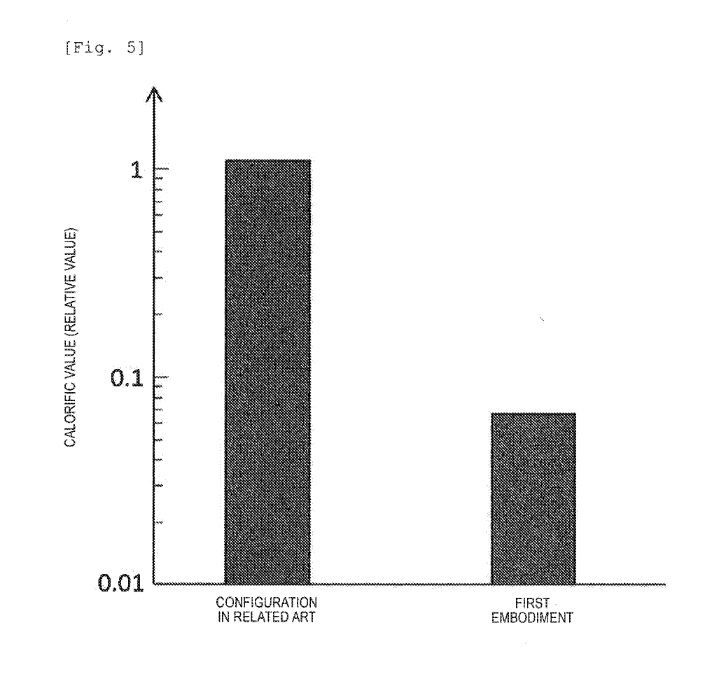

FIG. 5 illustrates a diagram of a relative comparison of a calorific value in the vicinity of the slot outlet of the stator between that in the related art and the present embodiment. It is understood that even when a voltage including a high frequency component is applied, heat generation of the low-resistance corona prevention layer can be greatly suppressed compared to that in the related art by using the conductive member according to the present invention, as illustrated in FIG. 5 in an example of the diagram of the relative comparison of the calorific value in the vicinity of the slot outlet of the stator between that in the related art and the present embodiment. As a result, it is learned that deterioration or a burnout of the low-resistance corona prevention layer can be prevented.

Moreover, it is desirable to provide the conductive member in the vicinity of the slot outlets of all the stator coils. However, it is possible to acquire the effect of the present invention, even though the conductive member according to the present invention is arranged particularly in only the stator coil of which heat generation is intended to be suppressed from occurring. For example, the conductive member according to the present invention may be arranged in only a first one or a plurality of the stator coils leading from a connection, portion from the inverter.

### Example 2

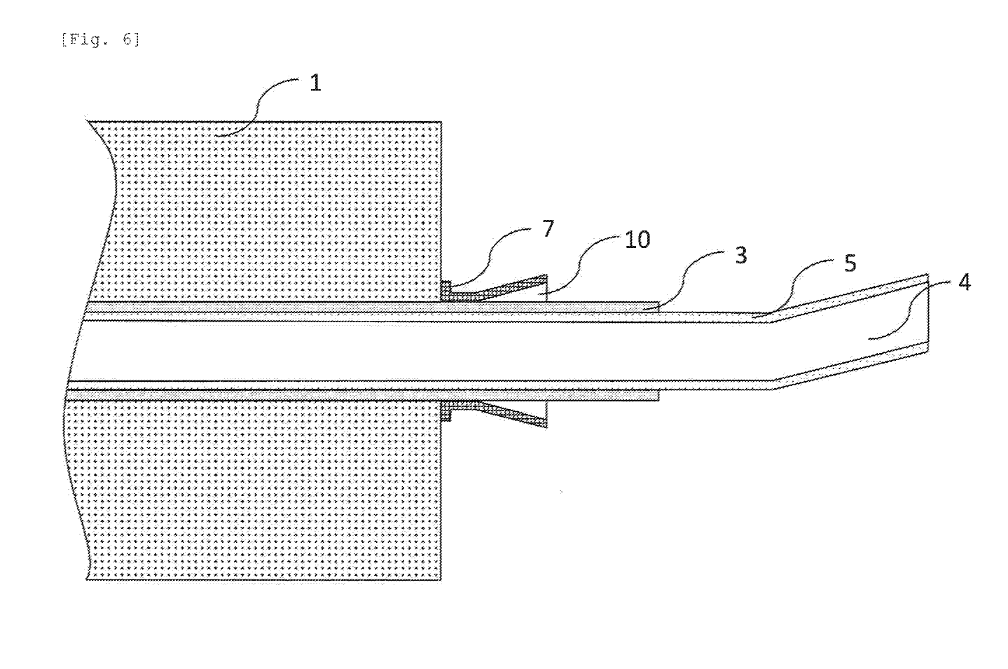

Subsequently, a second embodiment of the present invention will be described with reference to a schematic longitudinal sectional view in the vicinity of the slot outlet of the stator coil illustrated in FIG. 6. In the present embodiment, a different point compared to the first embodiment is that an insulation member is provided between the conductive member and the stator coil. It is possible to greatly decrease an influence of vibration by fixing the conductive member on the stator coil via the insulation member.

The insulation member may be formed of a resin such as epoxy, or an insulation material such as rubber.

Minute particles may be mixed in the resin. As an inorganic particle, for example, there is a generally known method in which an inorganic material such as boron nitride, silica, and alumina; or an organic material such as clay is mixed into the resin.

Similarly to Example 1, in order to achieve electrical connection between the stator core and the conductive member, it is possible to apply a method of arranging the conductive member on the stator coil so as to be in contact with the distal portion of the stator core, or a method of achieving electrical connection through a cable and the like.

In addition, since the conductive member is fixed, onto the stator coil via the insulation member, it is possible to maintain a desired distance between the stator core and the conductive member. Thus, electrical contact between the stator core and the conductive member may be achieved by partially fixing the conductive member to the distal portion of the stator core.

By arranging the conductive member in such a manner, even though a voltage including a high frequency component is applied, heat generation of the low-resistance corona prevention layer can be stably suppressed, and deterioration or a burnout of the low-resistance corona prevention layer can be prevented from occurring.

### Example 3

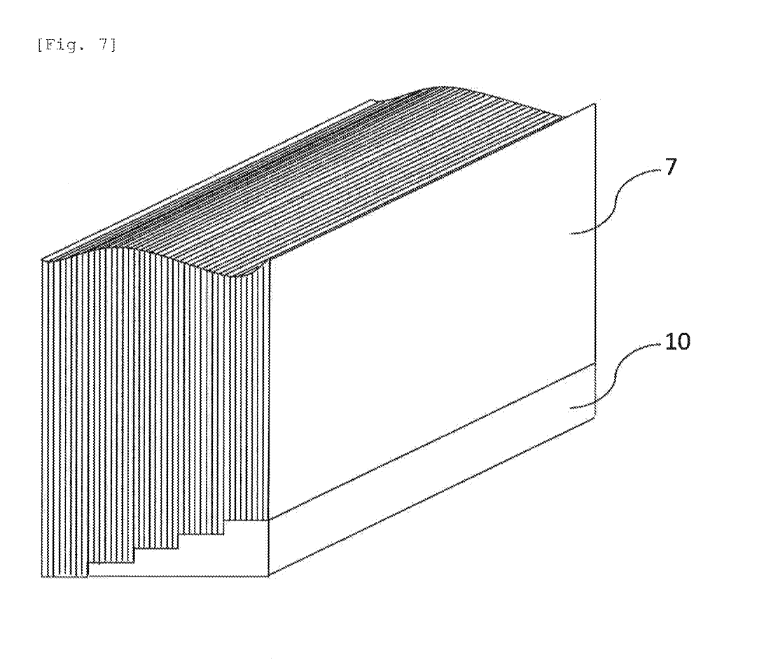

Subsequently, a third embodiment of the present invention will be described with reference to a schematic diagram of the conductive member illustrated in FIG. 7. A different point compared to the second embodiment is that the conductive member is formed by stacking a plurality of metal plates.

It is desirable that the distal portion is linearly tilted. However, it is possible to exhibit the effect similar to that in each of the aforementioned embodiments by stacking the metal plates so as to form the step-wise distal portion, thereby forming a structure in which a gap with respect to the stator coil is gradually widened.

### Example 4

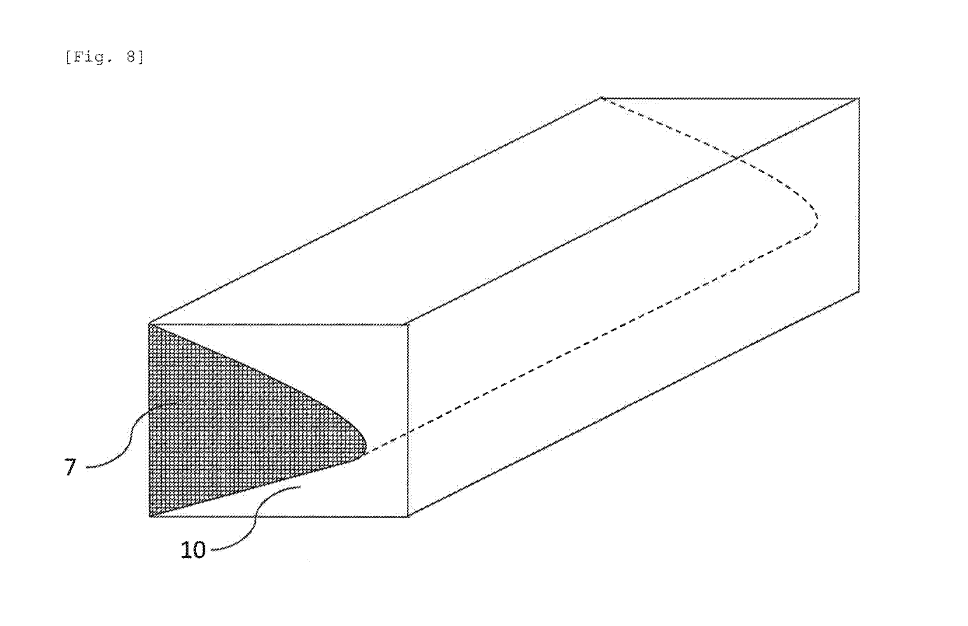

Subsequently, a fourth embodiment of the present invention will be described with reference to a schematic diagram of the conductive member illustrated in FIG. 8. A different point compared to the second embodiment is that the conductive member is formed with a bulk-like conductive member. It is desirable that a corner portion formed by surfaces not in contact with the stator core has moderate roundness. However, it is possible to achieve the effect of the present invention even though the corner portion is sharp.

The conductive member can be processed by being cut out from a metallic ingot. However, the method is not limited thereto. For example, the conductive member may be formed by pressurizing metallic powder so as to be compressed, or the conductive member according to the present invention may be formed by inserting a conductive resin into a mold so as to be hardened.

### Example 5

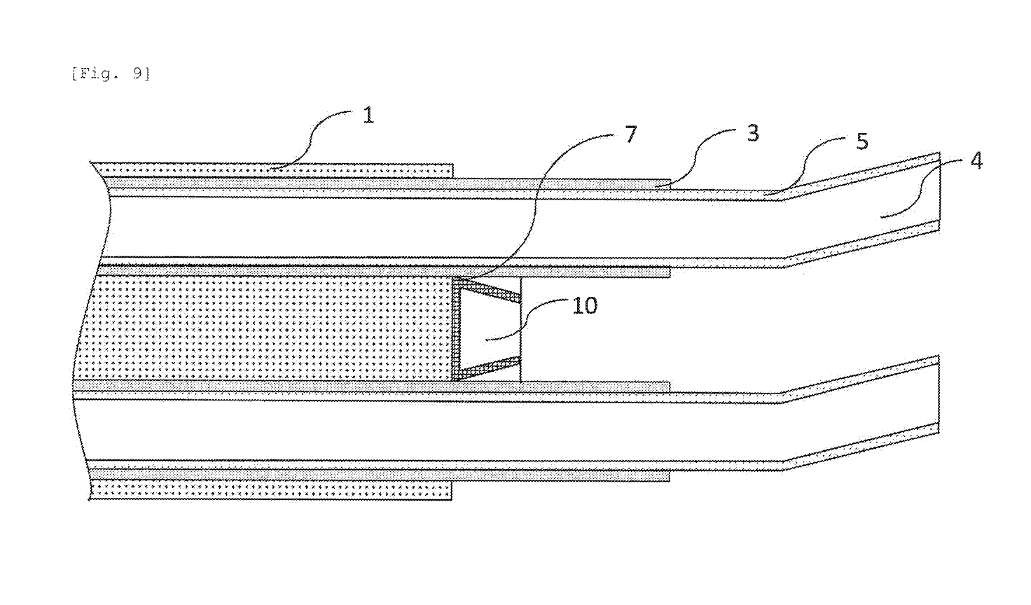

Subsequently, the fourth embodiment of the present invention will be described with reference to another schematic diagram of the conductive member illustrated in FIG. 9. A different point compared to the second embodiment is that one conductive member is formed to have a structure in which a gap with respect to the stator coil is widened as the conductive member is positioned away from the stator core in the rotary shaft direction of the rotary machine, with respect to the stator coils accommodated in the plurality of slots. It is possible to exhibit the effect similar to that in each of the aforementioned embodiments by arranging the conductive member so as to straddle the plurality of slots in such a manner.

### Example 6

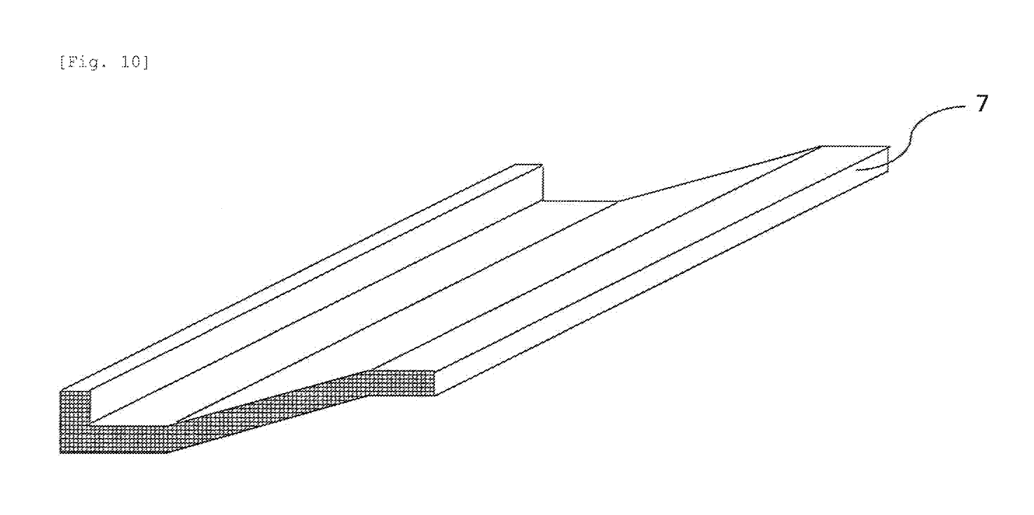

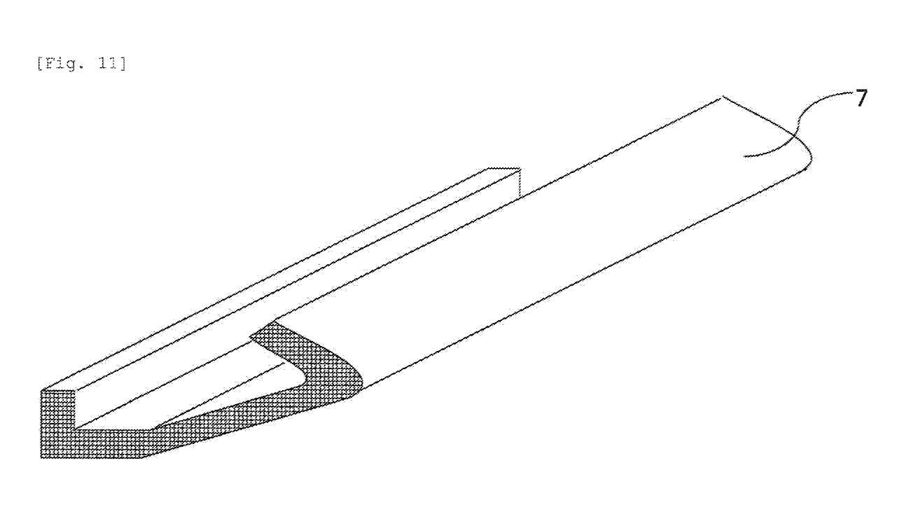

Subsequently, a fifth embodiment of the present invention will be described with reference to a schematic diagram of the conductive member illustrated in FIGS. 10 and 11. A different point compared to the first embodiment is that the distal portion of the conductive member is formed so as to be horizontal to the stator coil or to be bent toward the inside of the conductive member. The distal portion of the conductive member can exhibit the effect similar to that in each of the aforementioned embodiments by forming the conductive member so as to be horizontal to the stator coil or to be bent toward the inside of the conductive member.

When the conductive member is formed to cause the distal portion of the conductive member to be bent inwardly, it is desirable that a corner portion is formed by inwardly bending the distal portion of the conductive member so as to have moderate roundness. However, the corner portion may be sharp.

Each of the aforementioned descriptions has been given exemplifying an electric motor as the rotary machine. However, the rotary machine is not limited to the electric motor. Naturally, a generator can be also subjected to this application.

### REFERENCE SIGNS LIST

1 STATOR CORE

2 STATOR COIL

3 LOW-RESISTANCE CORONA PREVENTION LAYER

4 COIL CONDUCTOR

5 INSULATION LAYER

6 ELECTRIC FIELD RELAXATION LAYER

7 CONDUCTIVE MEMBER

8 STATOR

9 ROTOR

10 INSULATION MEMBER

1. A rotary machine comprising:
a stator that has a stator core; and
a rotor that is arranged so as to face the stator and is rotatably held, wherein in the rotary machine in which a stator coil having a low-resistance corona prevention layer wound around the stator coil is mounted on the stator core, a conductive member is provided at an end portion of the stator so as to have a widening gap with respect to the stator coil as the conductive member is positioned away from the stator core in a rotary shaft direction of the rotary machine.

2. The rotary machine according to claim 1, wherein the rotary machine is driven by an inverter.

3. The rotary machine according to claim 1, wherein an insulation member is formed between a conductive member and the stator coil.

4. The rotary machine according to claim 1, wherein the conductive member is electrically connected to the stator core.

5. The rotary machine according to claim 1, wherein the conductive member is configured to be made of metal of one type or a plurality of types.

6. The rotary machine according to claim 1, wherein the conductive member is formed of bulk metal in a single piece or a plurality of pieces, a metal plate in a single piece or a plurality of pieces, or both thereof.

7. The rotary machine according to claim 4, wherein, the conductive member is made with a member in which a plurality of sheets of iron plates are stacked.

8. The rotary machine according to claim 1, wherein, a distal portion of the conductive member is configured to be bent toward the inside of the conductive member or in the rotary shaft direction of the rotary machine.
